(19) United States
(12) Patent Application Publication
(10) Pub. No.: US 2005/0271292 A1
(43) Pub. Date: Dec. 8, 2005

(54) Lenticular imaging file manipulation method

(76) Inventor: Jeffrey A. Hekkers, Oconomowoc, WI (US)

Correspondence Address: WHYTE HIRSCHBOECK DUDEK S C, 555 EAST WELLS STREET, SUITE 1900, MILWAUKEE, WI, 53202, US

(21) Appl. No.: 11/142,820

(22) Filed: Jun. 1, 2005

Related U.S. Application Data
(60) Provisional application No. 60/577,291, filed on Jun. 4, 2004.

(51) Int. Cl. G06K 9/36; G06K 9/46

(52) U.S. Cl. 382/243

(57) ABSTRACT

A lenticular interlaced image file manipulation/screening method is disclosed. Frame files (which may or may not have already have been compressed) can be fractionally scaled in a coextending lenticular direction to obtain fractionally scaled frame files. Alternatively, frame files can be interlaced to create an interlaced frame file, which can be fractionally scaled. Prior to output, a screened interlaced frame file can then be normalized in a coextending lenticular direction to normalize the initial fractional scaling in the coextending lenticular direction. The invention permits manipulation of work files used to create a lenticular image so as to decrease lenticular image frame memory usage and file handling time, increase the number of frames in a lenticular image for use with high resolution output devices, and increase lenticular image quality.

### CROSS REFERENCE TO RELATED APPLICATIONS

This application claims the benefit of U.S. Provisional Application Ser. No. 60/577,291 filed on Jun. 4, 2004, the teachings and disclosures of which are incorporated herein by reference.

### BACKGROUND OF THE INVENTION

The present invention relates to lenticular imaging, and more specifically, to a process for manipulating an interlaced image file that is representative of an interlaced image.

Lenticular images can tell a story, show events over time, and can illustrate an object with an appearance of depth, that is, lenticular images can show an object in perspective. Motion can also be imparted. Thus, lenticular images can convey the illusion of multidimensionality (i.e., motion, with, or without, depth).

A lenticular image comprises an interlaced or precursor image that is joined to a lenticular lens for which it is designed and to which it shall correspond or substantially correspond so as to created a lenticular image that can properly impart a desired illusion, again, by way of example, motion (with or without depth).

A reference to motion pictures, or motion picture films, is often helpful in understanding lenticular imaging. Such films include a series of still frames or pictures. If the frames are projected in the proper sequence and frequency (e.g., 24 frames per second), then the illusion of motions can be created to a viewer viewing the film. In this way, the brain can perceive motion from a series of still frames.

Interlaced images are similarly created from a series or plurality of discrete or individual pictures or frames that are segmented and interleaved. The preparation of interlaced images for use in lenticular imaging is described in U.S. Pat. Nos. 5,488,451, 5,617,178, 5,847,808, 5,896,230, the disclosures of which are incorporated here by reference.

Lenticular lenses are known and commercially available. These lenses typically consist of an array of identical, semi-cylindrically curved surfaces that are extruded, embossed or otherwise formed on the front surface of a plastic sheet, although other geometric shapes or patterns are possible (e.g., elliptical, pyramidal, etc.). Each individual lens or lenticule is typically a section of a long cylinder that typically extends the full length of the underlying image to which it is laminated. The back surface of the lens material is typically flat. One example of a lenticular lens that can be used in the present invention is described in U.S. Pat. No. 6,424,467.

Lenticular images are created using an output device, and preferably, a high resolution output device. One such output device is a platesetter. The output, in this instance a plate, can be created using a Computer-to-Plate (CTP) process. Other outputs or output types (e.g., films, proofs, etc.) can be created, all potentially using high-resolution output devices. U.S. 2003/0016370, entitled “Corresponding Lenticular Imaging” discloses high resolution output of an interlaced image file and this disclosure is incorporated by reference here. The interlaced image file is preferably printed to the to the flat back surface of the lens. In this way, the interlaced or precursor image is joined to the lenticular lens to create the lenticular image.

Lenticular images are used in a variety of applications, including labels, packaging, end products such as containers, promotional items, and point-of-sale materials, among others.

A lenticular image again comprises an interlaced or precursor image that is joined to a lenticular lens for which it is designed and to which it shall correspond or substantially correspond so as to create a lenticular image that can impart an illusion of depth, again, with or without motion to a viewer. As used here, “joined” is typically the printing of the interlaced image directly to or on a flat or substantially flat back surface of the lenticular lens itself, but this joining as used here includes indirect printing which includes the lamination (e.g., using an adhesive) of the lenticular lens to the surface of the interlaced image that itself has first been printed to a substrate (e.g., paper, synthetic paper, plastic, metal, glass or wood). Joining can be permanent, semi-permanent, or temporary as appropriate to the application at hand. When printed directly to the flat back surface of the lenticular lens, the interlaced image can be displayed to a viewer using, for example, transmissive light (i.e., light passing through the lens), back-lighting, or in a reflective manner using an additional reflective coating or surface. The reflective coating can preferably be an opaque white or other suitable reflective coating and the surface can comprise, for example, paper. One use of a reflective coating applicable for use here is described in detail in U.S. Pat. No. 5,896,230, the disclosure of which is incorporated by reference herein.

The illusion of multidimensionality, with or without motion, is created when a viewer views the interlaced image through the lenticules of the lenticular lens at an appropriate viewing distance. The typical viewing distance for a viewer can vary. For example the view distance can be long (e.g., 12-20 ft.), or short (e.g., arm's length). The viewing distance is typically predetermined, depending on the product or particular application (e.g., packaging, labeling, and containers, among others).

In a high quality lenticular image, the size of printed dots that make up an interlaced image are directly related to the lenticular lens pitch and the number of frames that make up the interlaced image. The pitch, or resolution, can be measured in, for example, lenticules per inch (lpi). Advancements in lenticular lens technology have resulted in the creation and manufacture of lens with a higher pitch, for example, high definition lenticular lenses of the kind described in U.S. Pat. No. 6,424,467, referenced above. Moreover, output device having higher resolution capacities are being made more readily available.

Color scanners break down images into a plurality of continuous tone primary color separations (i.e., red, green and blue). These separations are converted to subtractive primaries (i.e., cyan, magenta, and yellow) plus black for printing. Alternatively, hi fi, hexachrome or other color gamut separation can be used, further converting the primaries into narrow color hues (e.g., cyan, magenta, yellow, green and orange) plus black. Regardless, the conversion represents the original picture.

It is well known in the graphic imaging art that images can be created using a computer system and stored using one of a number of computer readable mediums. These mediums can include, for example, RAM, hard drive, CD ROM, DVD, tape, and optical means. A variety of file formats can be used, for example, TIFF, JPEG, Photoshop®, and EPS, among others.

Computer-to-Plate (CTP) technology is a plate-imaging process in which printing plates are imaged directly from digital files. As such, the need for photographic films is eliminated. Components of a typical CTP system include a raster image processor (RIP), a plate-storing location, a device(s) for removing slip sheets, a punching device(s), system(s) for loading and unloading plates, a plate setter, and a post-processing system.

As technology improves, including more frames under lenticular lens media of higher pitch is a desirable path for advancement in the lenticular industry. However, increasing the number of frames used to create an interlaced image, using available screening methods, results in an overall reduction in dot size. Such a reduction increases the difficulty in manufacturing outputs, such as printing plates. It also becomes more difficult using current technologies to sustain a high-quality production throughout a run of printed pieces.

When a printed dot is actually output, for example to paper, or to a lenticular lens material made of plastic, there is ink absorption and ink spread. The amount of absorption and spread depends on the material. When ink spreads, printed dot size grows. Such “growth” is referred to as dot gain and, in essence, dot gain results in a printed dot being larger than the specified dot size. The greater the dot gain, the greater the degradation of image quality. One type of image degradation caused by dot gain can include an undesirable color change.

Increasing the number of frames included in a lenticular image (e.g., from 12-24 frames) increases the effects of the lenticular image for a viewer (e.g., by provided greater continuity, clarity, etc.). However, increasing the number of frames also increases the amount of information that must be accounted. Increasing frame information results in increased file sizes, and longer time to manufacture, due to longer file handling and storage time. This is particularly true in lenticular images where multiple files (e.g., representative of frames) are compiled into one file. Limits are being tested as to the smallest size dot that can be reproduced and held in current printing and plating techniques.

Accordingly, it would be desirable to provide a file manipulation or screening method that can be utilized with current and future high-resolution output devices such that dot size can be increased (or maximized), thereby reducing or minimizing dot gain. In this fashion, it would be desirable to provide a cost-effective method that increases the likelihood that a proof or print will be at least of the same or substantially same quality as an approved proof or print. It would be also be desirable to provide a screening method that can reduce the size of working files (e.g., frame files) so as to reduce time to manufacture and storage or memory requirements. The screening method would preferably result in a high quality, commercially viable, lenticular image.

### BRIEF SUMMARY OF THE INVENTION

The present invention provides a novel and efficient method for providing lenticular images.

In one embodiment, a lenticular image file manipulation method for use with high resolution output devices the method comprising: providing a plurality of frame files; compressing the frame files in a translenticular direction to obtain a plurality of compressed frame files; fractionally scaling the compressed frame files in the coextending lenticular direction to obtain a plurality of fractionally scaled, compressed frame files; interlacing the fractionally scaled, compressed frame files to create an interlaced frame file; screening the interlaced frame file to obtain a compressed, screened, interlaced image file; and normalizing the compressed, screened, interlaced frame file in the coextending lenticular direction prior to output of the file.

Advantageously, dot gain is reduced, thereby reducing image degradation and improving color fidelity. Moreover, work file size is decreased, thereby decreasing memory storage/archiving space and increasing file handling and manipulation speed.

These and other important features, hallmarks and objects of the present invention will be apparent from the following descriptions of this invention that follow. In addition, other embodiments, aspects and advantages will become apparent in view of the teachings that follow, including the drawings.

### BRIEF DESCRIPTION OF THE DRAWINGS

The drawings illustrate the best mode presently contemplated for carrying out the invention.

In the drawings:

FIG. 1 is a schematic illustration of a digital frame with a plurality of digital frame segments that can be used with the present invention;

FIG. 2 is a schematic illustration of an exemplary interlaced image having a plurality of digital frame segments and with the image shown prior to joining the interlaced image to a lenticular lens;

FIG. 3 illustrates a screenshot of compressed, interlaced, screened image file;

FIG. 4 shows an enlarged view of the image file of FIG. 3;

FIG. 5 shows a screenshot of the compressed, interlaced, screened image file where the image file has been fractionally scaled according to on aspect of the present invention;

FIG. 6 shows a screenshot illustrating an enlarged view of the image file of FIG. 5;

FIG. 7 shows a screenshot illustrating an enlarged view of the image file of FIG. 5 where the image is normalized according to one aspect of the present invention; and

FIG. 8 is a lenticular image incorporating an interlaced image created according to one aspect of the present invention.

### DETAILED DESCRIPTION OF THE INVENTION

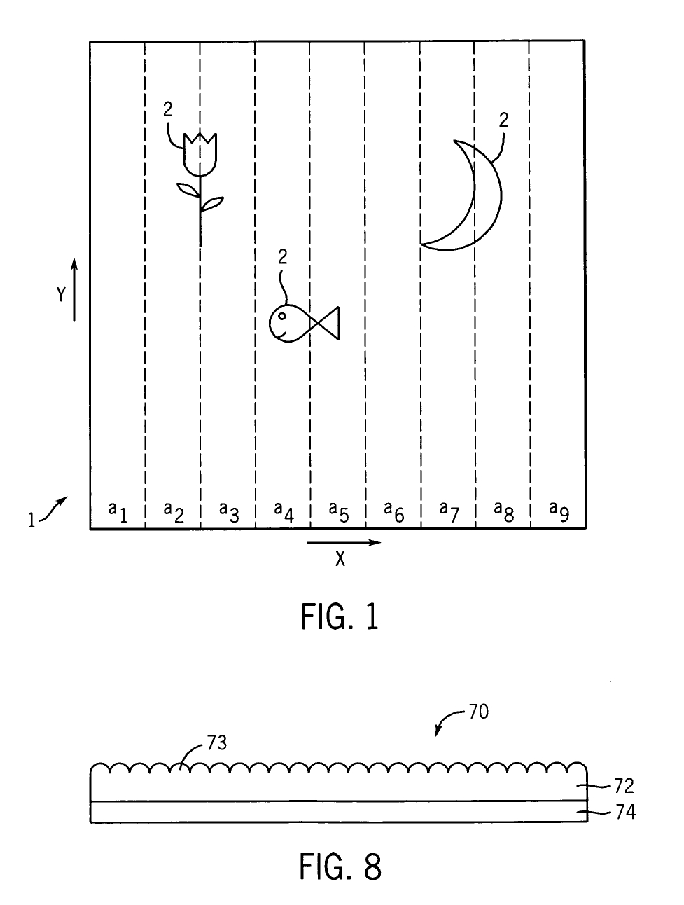

FIG. 1 shows a schematic illustration of a digital frame 1 that can be stored in a computer file. A digital frame can include picture elements, base pictures, or base images (e.g., a tree, a person, etc.), collectively referred to by numeral 2, that are in electronic (i.e., pixel) form. Illustrative base images include: photographs, graphics, typeface, logos, animation, video, computer-generated or digital art, vignettes, tints, dimensional art, graphs, charts, vector art and similar information. These images can be in digital form initially, for example, if they are created using a digital camera or digital video camera. If the base images are not initially in digital form, then they can be converted into digital form using, for example, optical scanning apparatuses and methods. Once the base images are converted into digital form, the digital frame can be created using known software programs, for example, Adobe® Photoshop®. As a practical matter, digital frame 1 is representative of the image that is stored in a computer file, or the image prior to output.

The complexity of digital frame 1 depends on a number of factors, for example, the number of base images, whether vector and/or graphic components are used to make up the frames, and the desired effect of the final interlaced images (i.e., whether the intended effect includes multidimensionality and/or motion). Digital frames can have images placed within them at different “layers”, meaning that the images can be added, subtracted, moved, sized, adjusted, filtered or otherwise manipulated to a user's convenience to accomplish the desired illusions or special effects.

Numerous data entry conventions may be used. For example, in a preferred embodiment, using conventional software, a single digital frame resolution can be selected or input for both the width and height directions of a digital frame. “Digital frame resolution” refers to a resolution that corresponds to a predetermined number of pixels per lineal distance, such as inches, centimeters, picas, etc. In some applications it may be standard or common practice to enter a single value representative of a digital frame resolution, and in other applications, a first digital frame resolution and a distinct second digital frame resolution can be incorporated.

In order to create an interlaced or precursor image that will provide a viewer with an illusion of multidimensionality (i.e., when the interlaced image is joined to and viewed through an appropriate lenticular lens), additional digital frames can be created in a similar fashion to that of digital frame 1. Typically, twelve digital frames are interlaced with one another to create an interlaced image, although the number of frames can vary to convenience, for example from 2 to 96, or even more. Digital frames can be repeated when ordering and creating the interlaced image. In this way, certain (e.g., a subset) of the digital frames can be given additional weight relative to other digital frames in the interlaced image, and ultimately, the lenticular image. Digital frames that are given greater weight in the interlaced image are commonly referred to as “hero” frames.

The digital frames are then interlaced. Interlacing can be accomplished as follows: digital frame 1 is segmented (i.e., divided) into frame segments (i.e., a₁, a₂, a₃, . . . , a₉). As a practical matter, a segment of a frame is typically in the form of a rectangular column and the height and width of each such column is typically the same, from column to column (i.e., the height and width of frame segment a, is typically the same or substantially the same as the height and width of frame segment a₂). The remaining frames are similarly segmented into digital frame segments. For example, a second frame “b” (not shown) can be segmented into segments b₁, b₂, . . . , b₉. Once created, the digital frames can be ordered, and their respective frame segments interlaced into a desired sequence to create an interlaced image. The “desired sequence” of digital frames (and their respective frame segments) is the sequence that can impart the desired illusion of multidimensionality to a viewer of the interlaced or precursor image when the image is joined to, and viewed through, a lenticular lens.

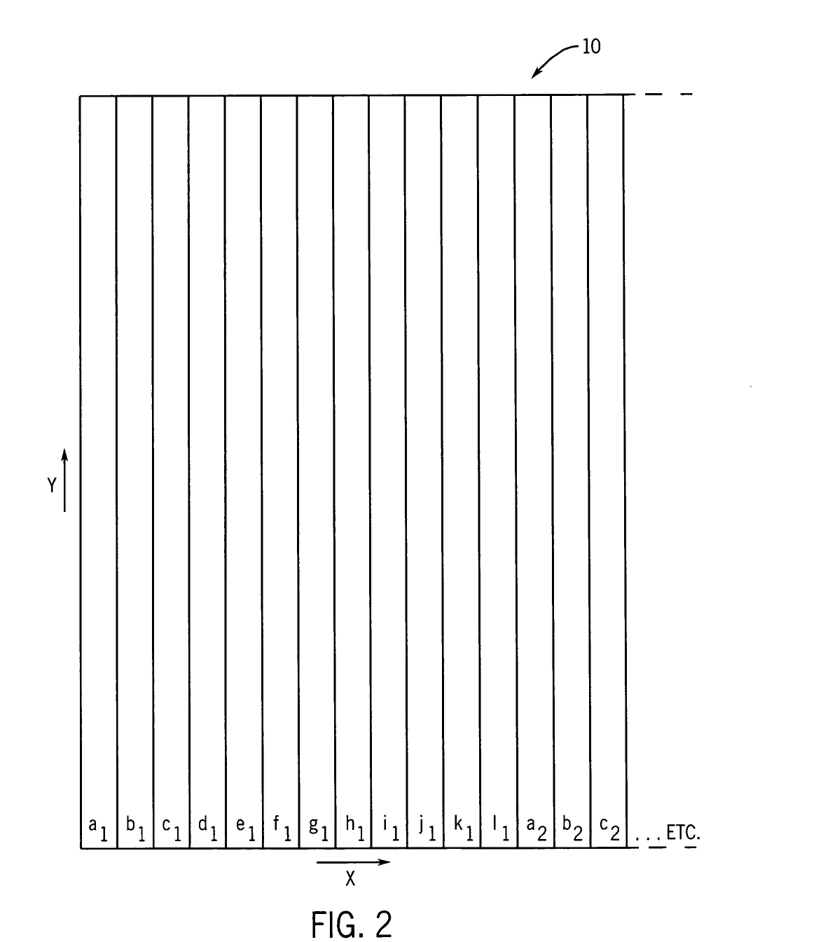

FIG. 2 shows a schematic illustration of an interlaced image file 10 that can be stored in a computer (i.e., it is a representation of the image prior to output). In general, interlaced image 10 comprises a plurality of digital frames that have been arranged in the desired sequence, segmented and interlaced to create the interlaced image. Thus, interlaced image 10 is formed by interlacing digital frames (i.e., digital frames “a”, “b”, “c”, . . . , “l”), each of which has been segmented into their respective digital frame segments a₁ through a₉, b₁ through b₉, and c₁ through c₉ (not all of which are illustrated). Interlacing is typically accomplished using computer software designed for such interlacing, although it can also be accomplished by manual manipulation of the pixels. As a practical matter, however, as images become more complex, manual manipulation becomes more tedious and cumbersome and, as such, less practical. Masking, deleting, layering, or other pixel/image selection techniques can also be used in the creation of an interlaced image.

Referring to FIGS. 1 and 2, digital frame file 1 and interlaced image file 10 are two-dimensional files and directions can be assigned to each dimension so that the directions correlate to the orientation or direction of the lenticular lens to which the interlaced or precursor image (made from the frame and image files) will eventually be joined. As shown, the “x” (or negative x) direction is oriented substantially perpendicular to (also called “across”) the lenticules of the lenticular lens to which it will be subsequently joined. More specifically, the “x” direction corresponds to a direction that is transverse the lenticules of a lenticular lens to which the interlaced image file will be joined, when output using, for example, a high resolution output device. Thus, the “x” direction is referred to herein as the “translenticular direction”. The “y” (or negative y) direction, as used herein, is a direction substantially parallel to or “with” the lenticules of the lenticular lens. More specifically, the “y” direction corresponds to a direction that is parallel to the lenticules of a lenticular lens to which the interlaced image file will be joined, when output using, for example, a high resolution output device. Thus, the “y” direction is referred to herein as the “coextending lenticular direction”.

These coextending lenticular and translenticular dimensions and their orientations are described for purposes of clarity and specificity, however, they should not be interpreted in any limiting way. Other orientations are possible. Moreover, the coextending lenticular and translenticular directions, as described herein, are oriented perpendicularly with respect to each other. However, it will be apparent to those of skill in the art that the frame and interlaced image resolutions can be oriented or arranged to correspond to other angles, directions as desired without departing from the scope of the invention.

Files are typically compressed to improve the efficiency of their storage (e.g., on a disk or other media) and transfer (e.g., over a network such as the Internet). In general, compression refers to a “reduction”, for example, the reduction of file size. There are generally two broad categories of compression: “lossy” and “lossless”. “Compression”, as herein used, includes both “lossless” and “lossy” compression techniques and it includes techniques in which some pixels are retained or discarded. “Masking”, “scaling” “interpolation”, “deleting”, “averaging” are other techniques in which pixels, pixel information, or digitized frame information is manipulated.

The digital frames can be compressed, segmented and subsequently interlaced. It is also contemplated that compression can take place prior to, after, or substantially simultaneously with or during the interlacing of the digital frame segments so to create a desired interlaced image. Compression typically takes place in the translenticular direction. In this direction, compression is expressed as the reciprocal of the number of frames per lenticule, i.e., compression=1/f, where “f” is the total number of frames in the interlaced image (e.g., if 12 frames are used, f equals 12 and compression is equal to 1/12). In alternative preferred embodiments, compression in the translenticular direction can also be expressed as a multiple, or factor, of 1/f. Digital frames are typically compressed such that the compression of each frame is a function of the total number of frames in the interlaced image.

Compression of the interlaced image made up of the digital frame segments can also be accomplished. The interlaced image resolution in the translenticular direction is a pixel resolution that corresponds to the resolution of the line count of the lenticular lens (“L”) times the number of frames (“f”) used to create the interlaced image, or simply:
L×f.

The line count of the lenticular lens can vary to convenience, and is typically between 10 and 400, or even more lines per lineal inch (lpi). The line count or “pitch” is highly dependent on the application at hand. For example, a coarse lens (e.g., on the order of about 10-50 lpi) can be used for a bus shelter signage. Even coarser lenses can be used in certain other applications, such as billboards. On the other hand, a fine lenticular lens (e.g., on the order of about 150-400 lpi) can typically be used for a label comprising small type fonts or sizes (e.g., on the order of about 9 pts. or even less).

Typically little, if any, compression takes place in the coextending lenticular direction since interlacing does not take place in this direction. As such, pixel information (again the frames are in digital form) in coextending lenticular direction typically remains in a noncompressed or essentially noncompressed state. As will be described in greater detail below, the resolution and size of digital frame and interlaced image files can be varied, by scaling the file in the coextending lenticular direction.

The process of converting a continuous tone image to a matrix of dots in sizes proportional to the highlights (i.e., the lightest or whitest area of an image) and shadows (i.e., the darkest portions of the image) of the continuous tone image is referred to as “screening”. Image screening techniques can include, for example, half-tone screening and stochastic screening. In conventional half-tone screening, the number of dots per inch remains constant, although the size of the dots can vary in relation to the tonal range density of the pixel depth that they represent. When making color separations, screen angles must be rotated so as to avoid moire interference. Moire is an undesirable optical effect that results from an out-of-register overlap of patterns. Conventional screen angles of rotation that can be used to eliminate or substantially eliminate moire interference are: 0 for yellow, 45 degrees for magenta, 75 degrees for cyan, and 105 degrees for black. Since angles can be interchanged, or skewed, as a whole, dots composed of multiple pixels, can create moire problems which are essentially the result of repetitive nature of the dissimilar pixels. Moreover, the angling of the half tone screens can result in a rosette pattern. Half tones can interfere with viewing the image through the lenticular lens by creating screen interference and/or moire.

Stochastic or frequency-modulated (FM) screening can create the illusion of tone with variably-spaced dots. Stochastic screening techniques typically yield higher resolutions than are typically obtained in conventional half-tone dot screening. Stochastic screening utilizes finer spots, and results in a higher resolution such that screen rotation, and the formation of rosette patterns can be eliminated. The dots or spots themselves can take different shapes (e.g., round, rectangular, among others). Stochastic screening techniques can virtually eliminate moire and screen interference. It has been found that stochastic screening can result in higher dot gain on press and, when making a plate or a proof, precise exposure control is needed. Still, plate setters eliminate the step of creating a film and the additional dot gain that accompanies its production. Plate setters can be calibrated for accurate screen reproduction. In general, stochastic screening is preferable when smaller or finer images are utilized, for example, on the order of 30 to 10 microns, or even less. The present invention provides advantages in the stochastic screening environment, and, in general, reduces dot gain and increases color fidelity in a more efficient file handling environment.

The timing of screening can be varied to convenience. For example, screening processes, whether using halftone, stochastic, or any other technique, can take place prior to interlacing, after interlacing but prior to sending the interlaced image to an output device (preferably a high resolution output device), or after sending the interlaced image to the Raster Image Processor, that is, a “RIP”, (e.g., Scriptworks®, available from Harlequin® of Chicago) of the output device.

Screening to binary file format is preferable in many instances. Raster data prints a page as a pattern of dots or spots. To place the dots, the RIP maps out the page as a grid of spot locations—called a bitmap. Thus, a RIP converts the interlaced image file to bitmap data for outputting since bitmapped data can be accommodated by the output device that ultimately outputs the final image (i.e., an interlaced image which is joined to a lenticular lens) as dots.

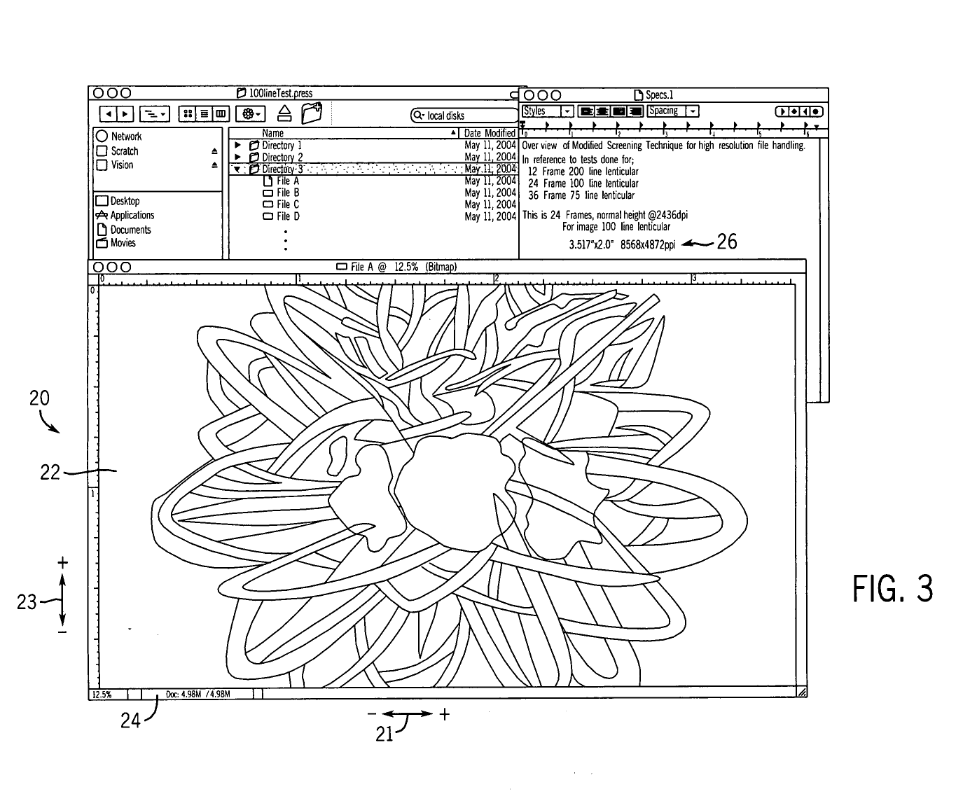

FIG. 3 illustrates a exemplary screenshot 20 (as illustrated, using a Macintosh® operating system) of a compressed, interlaced, screened image file 22. File 22 is a composite image that is created from a plurality of individual frame files (see FIG. 1). As indicated at reference numeral 24, the actual file size of the image file 22 shown, is, in this instance, 4.98 Megabytes. This value varies according to the number of frames used to create the interlaced image file and the intended lenticular lens resolution or pitch of lens to which the file 4 will ultimately be output using, for example, a high resolution output device. In this instance, the intended lens has a pitch of approximately 101.5 lines per inch (ipi), and this lens is known in the art as a “100 line lens”). The lenticular lens to which the file will be ultimately output, thus, is a factor in the present invention. The discrete lines visible in the screenshot 20 correspond to the resolution of the lenticular lens that will overlay the interlaced image, once output.

The file 22 is intended to be viewed at 100% size (i.e., the file is at its ultimate intended, physical, or typically printed, size). In this context, “size” refers to physical size of the image file, for example, the linear width by linear height. As illustrated, the width corresponds to the translenticular direction, indicated by arrow 21, and the height corresponds to coextending lenticular direction, indicated by arrow 23. As indicated at numeral 26, the physical size for the file is 3.517″ in the translenticular direction 21×2.0″ in the coextending lenticular direction 23. Still referring to numeral 26, the image file resolution in the translenticular direction is 8568 pixels per inch (ppi) and the resolution in the coextending lenticular direction is 4872 ppi.

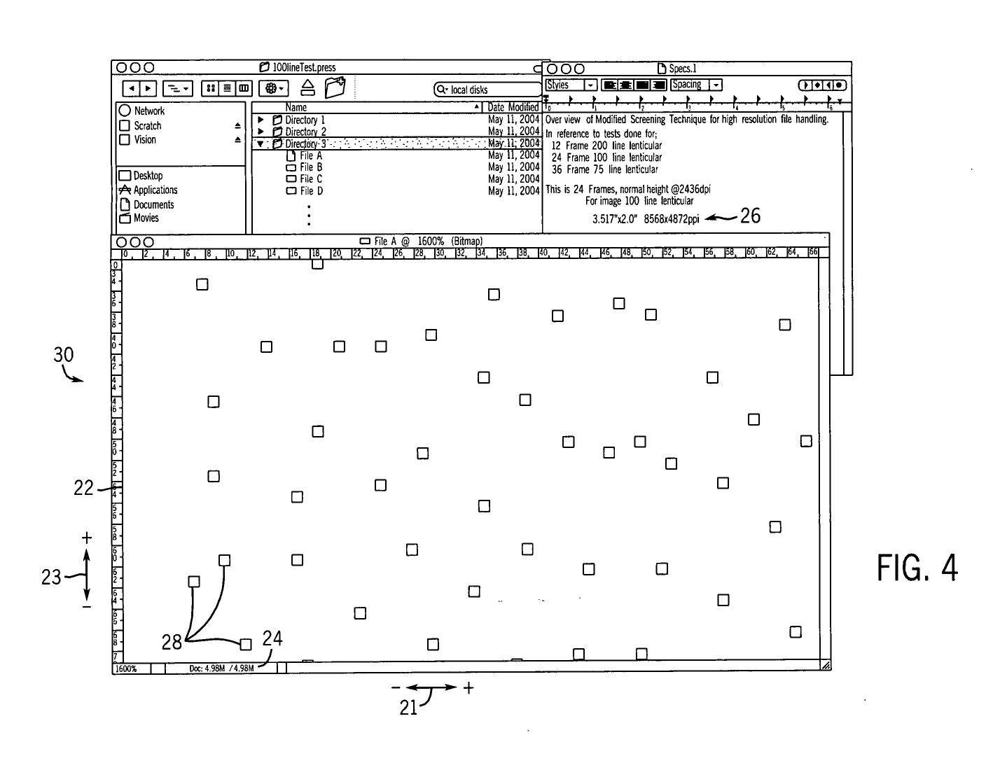

FIG. 4 shows a screenshot 30 showing an enlarged view of the image file 22 of FIG. 3. Again, as indicated by numerals 24, the file size 4.98 Megabytes. Again, the physical size of the file 22 is 3.517″ in the coextending lenticular direction, indicated by arrow 21, and 2.0″ in the translenticular direction, indicated by arrow 23. FIG. 2 illustrates individual dots 28, with each dot having a surface area. In the view shown, the surface area of each dot occupies a space of 1 pixel (i.e., picture element). Stated another way, 1 pixel corresponds to 1 printable dot. In this way, FIG. 4 includes a pixel representation of printable dots. Other correlations between pixels and printable dots are contemplated and considered within the scope of the present invention.

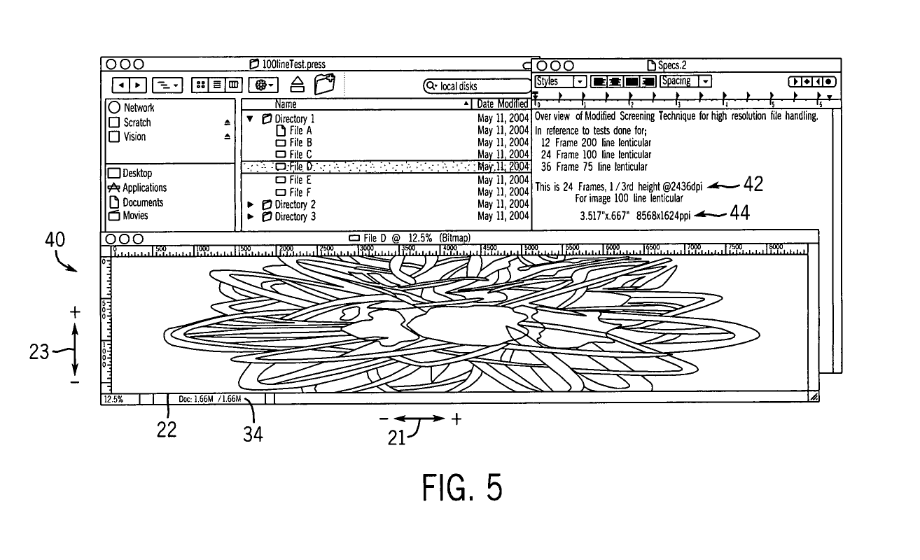

FIG. 5 shows a screenshot 40 of the compressed, interlaced, screened image file 22 of FIG. 3. The image file 22 is again a composite file created from a plurality of, in this case twenty four, individual frame files (see again, FIG. 1), and this is indicated at numeral 42. Frames are compressed in the translenticular direction, indicated by arrow 21. Again, the precise compression is related to the individual lenticular lens pitch to which the interlaced image will ultimately be joined. In this example, in the translenticular direction, the individual frame files that are used to create file 22 have been compressed so that the physical size of file 22 is 3.517″ and so that the frames are 1/24 of their original size.

Additionally, the image file 22 of FIG. 5 has been fractionally scaled according to one aspect of the present invention. Accordingly, each of the frame files (again, in this case 24 frame files were used) that make up image file 22 are fractionally scaled in the coextending lenticular direction, indicated by arrow 23 to a fraction, in this instance ⅓, of its original size (which is shown in FIG. 3). As indicated at numeral 42, in the example shown, each of the twenty four frames that make up the interlaced image have been interlaced and scaled for use with a lenticular lens resolution of 101.5 lines per inch. The interlaced image is suitable for output using, in a preferred embodiment a high resolution output device, at 2436 dots per inch (dpi).

Referring to FIGS. 3 and 5, advantageously, the file size, physical size and pixel count are reduced as a result of fractional scaling in the coextending lenticular direction, indicated by arrow 23. File size has been reduced from 4.98 Megabytes, indicated at reference numeral 24 in FIG. 3, to 1.66 Megabytes, indicated at reference numeral 34 in FIG. 5. Comparing FIGS. 3 and 5, the physical size of the file, indicated at numerals 26 and 44, respectively, remains at 3.517″ in the translenticular direction, indicated by arrow 21. However, in the coextending lenticular direction, indicated by arrow 23, the physical size has been reduced from 2.0″ to 0.667″, also indicated by numerals 26 and 44, respectively. This reduction is illustrative of fractional scaling according to one aspect of the present invention. Stated another way, the image file 22, or the frame files that make up the image file, is or are fractionally scaled in the coextending lenticular direction to one third of its or their original size. Finally, as indicated at numeral 26 in FIG. 3 and 44 in FIG. 5 the image file resolution has been reduced from 4872 to 1624 ppi in the coextending lenticular direction, while remaining at 8568 ppi in the translenticular direction. In at least one preferred embodiment, the fractional scaling takes place on a screened binary file.

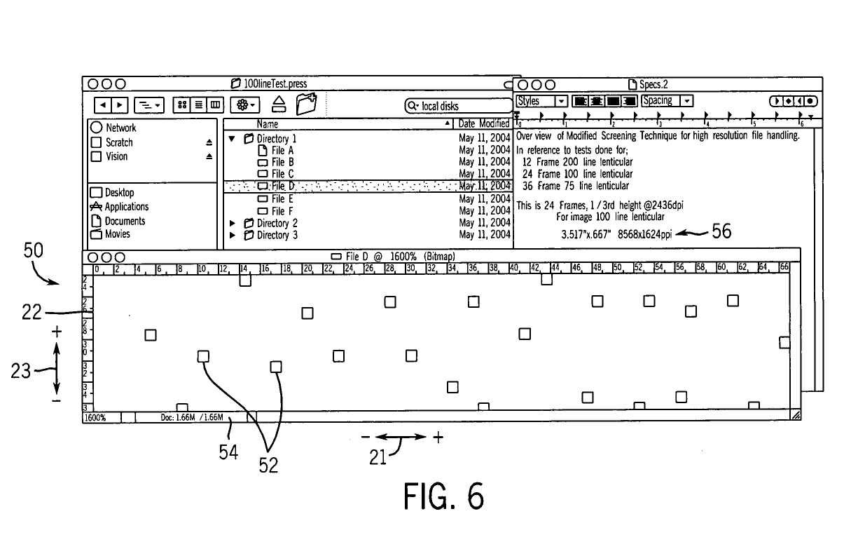

FIG. 6 shows a screenshot 40 illustrating an enlarged view of the image file 22 of FIG. 5. Individual pixels 44 (or a pixel representation of a dot) are depicted. In comparison to FIG. 4, the interlaced image file is fractionally scaled to ⅓ of its original size in the coextending lenticular direction, indicated by arrow 23 . With reference to numerals 54 and 56, and in comparison to FIG. 4 at numerals 24 and 26, respectively, the file size and pixel count have been reduced due to the fractional scaling technique employed (i.e., from 4.98 Megabytes to 1.67 Megabytes and from 4872 ppi to 1624 ppi, respectively).

While the file size, physical size and pixel count have been reduced by ⅓ of its original size, it is noted here that any fractional scaling is possible (e.g., ½, ¼, etc.) and considered within the scope of the present invention. In a preferred embodiment, the amount of fractional scaling can be a factor or multiple of the compression ratio (e.g., in the embodiment illustrated, the file(s) are scaled in the coextending lenticular direction according to a scaling factor of ⅓, which is a multiple of 1/24).

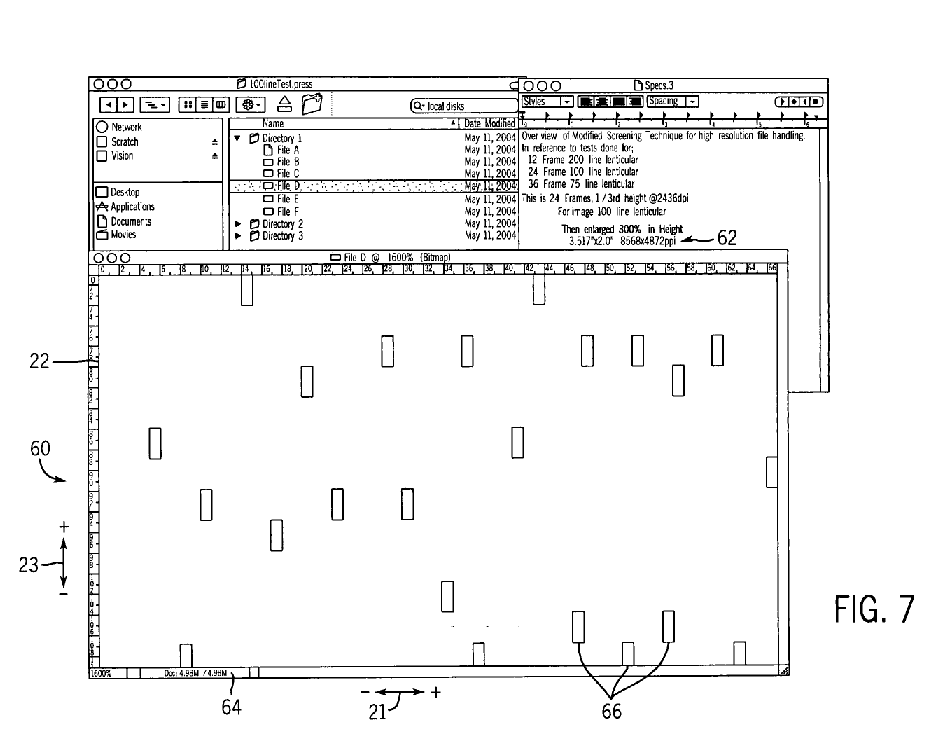

FIG. 7 shows a screenshot 60 illustrating an enlarged view of the image file 22 of FIG. 5. In the translenticular direction, indicated again by arrow 21, the image file 22 has a physical size of 3.517″ and a resolution of 8568 ppi, with these values indicated at arrow 62. However, and significantly, the image file 22 is normalized according to one aspect of the present invention so as to accommodate the fractional scaling of the interlaced image previously accomplished. In this instance, the interlaced image file 22 has been normalized in the coextending lenticular direction, indicated by arrow 23. Accordingly, in the coextending lenticular direction, the image file 22 has a physical size of 2.0″ and a resolution of 4872 ppi, with these values again indicated at arrow 62. The file size, indicated at arrow 64, is 4.98 Megabytes. Comparing FIG. 7 with FIG. 4, the file size and resolution are the same.

In the present invention, normalizing scales by a normalizing scaling factor and the fractionally scaling scales by a fractional scaling factor. The normalizing scaling factor is typically inversely proportional to the fractional scaling factor. The fractional scaling factor is less than 1 and the normalizing scaling factor is greater than 1. Advantageously, the normalizing increases a surface area of a high resolution output dot size. Normalizing is typically accomplished at the binary interlaced file stage in a program such as Adobe® Photoshop®. Normalizing can also be accomplished in a page layout program such as Adobe® In-Design ®, or Quark® Xpress, or at the RIP stage of a workflow.

Normalizing is typically inversely proportional to the fractional scaling previously accomplished. As a result, 3 pixels correspond to a printed dot or spot, which are indicated by numeral 66. Accordingly, dot size is increased, and it is increased in a manner, or by an amount, that is inversely proportional to the fractional scaling employed.

As with FIGS. 4 and 6, a pixel representation of a dot is shown. Comparing FIG. 7 with FIG. 4, each dot 66 is three times as large as each dot 28 in that, in FIG. 7, dots 66 comprise 3 pixels. Thus, each dot 66 has three times the printable surface area of each dot 28, and thus, dot gain (given the same output environment) will be reduced. In this way, increasing dot size, reduces dot gain. Accordingly, a viewer viewing the lenticular image produced in accordance with this method will experience less print degradation.

It is noted that the files described and depicted here are in a binary format, or in other words, the files are shown such that pixels (or pixel representations) are either on or off. In this format, the pixel count and file size reduction correspond to the fractional scaling that takes place (e.g., if physical size is reduced to ⅓ of its original size, the file size and pixel counts are reduced by ⅔). Reducing file size advantageously improves file transfer, storage and manipulation, thereby increasing speed and efficiency in the creation of lenticular imagery. It is contemplated that fractional scaling can take place at virtually any stage in the creation of a interlaced image that can be joined to a lenticular lens to create a lenticular image. For example, frame files, interlaced image files, interlaced image segments and associated files, can be fractionally scaled. In general, the earlier in the process that fractional scaling takes place, the greater the benefit in terms of resulting file storage space savings and manipulation and/or handling time savings. Once fractional scaling has been completed, all subsequent files that are used in a work flow to create a lenticular image are smaller, and thus, more easily transferred, manipulated and stored. In a preferred embodiment, a file is screened and fractionally scaled to a binary format and normalized at or just before the time of output so as to allow for improved file handling and placement of files in layout programs when size has been reduced.

The appropriate lenticular lens is selected to accommodate the image and the predetermined viewing distance. For a large application, such as a billboard or bus shelter, or a vending machine facade, a thick, coarse lenticular lens is usually preferred. For smaller application, such as a cup, a label or a package, a fine lenticular lens is typically preferred. Coarse lenticular lenses have fewer lenticules per linear inch than fine lenticular lenses. Other factors often considered in the choice of a lenticular lens include the thickness, flexibility, the viewing distance, the cost of the lens, and the method of printing the image (e.g., sheet-fed, lithographic, web, flexography, screen-print, etc.), among others.

The interlaced image can then printed directly (as described above) to the typically substantially flat back surface of the appropriate lenticular lens. Alternatively, an indirect printing method can be used in which the interlaced image is printed to a substrate, and the image and substrate subsequently joined (e.g., using an adhesive) to the lenticular lens. In yet another embodiment, an interlaced image can be joined in a nonpermanent fashion to the lenticular lens so that the position of the image can be altered or adjusted with respect to the lens, or the image itself interchanged. In all of the above-described instances, correspondence between the interlaced image and lenticular lens is maintained, as shown and described herein.

As used in the context of a lenticular image, “correspondence” means that each interlaced segment is covered or substantially covered by one lenticule and that the lenticule and interlaced segment are substantially congruent with one another. Correspondence is easily confirmed by viewing the interlaced image (i.e., the image comprising the interlaced segments arranged in the desired order) through the lenticular lens (i.e., the lenticular image) at a predetermined or desired viewing distance. As a practical matter, there is typically not a precise one-to-one correspondence between an interlaced image segment of a corresponding interlaced image and the lenticule of the lens which overlays the segment. Rather, each interlaced image segment may be made coarser (i.e., wider) or finer (i.e., narrower) than the lenticule of the lens which overlays it. For example, to accommodate an increase in size of an interlaced image during printing, a phenomenon known as “press growth”, interlaced image segments are typically designed or created to be finer than the lenticules of the lens which will ultimately overlay them. Again, correspondence can be confirmed by viewing the interlaced through the lenticular at a predetermined or desired viewing distance to determine whether the desired illusion of multidimensionality is created.

Although the construction of an interlaced image has been described from the perspective of columns, interlaced images can also be constructed from the perspective of rows or other groups of pixels if particular effects are desired. For example, creating motion from an array of rows allows the composite image to be displayed in any perspective forward of the viewer, e.g., in an overhead, on a wall or billboard, in a floor panel, etc. As the viewer moves toward the display, regardless of angle, but preferably from a relatively perpendicular approach, the viewer perceives the intended motion.

Specific types of lenticular images include, but are not limited to, “flip images,” “morph images,” and “zoom images,” among others. Flip images comprise at least 2 base images and can impart motion and/or change from one image to another as the viewer's position changes with respect to the lenticular image being viewed. Morph images are similar to flip images except that images transform or more fluidly change from one image to another as the viewer's view position changes. Zoom lenticular images, as the name implies, provides the illusion of image magnification as a viewer's viewing position with respect to the interlaced image being viewed changes.

The process of this invention is preferably a direct lithographic process that eliminates the need to output intermediate art that would later require separation from the interlaced image (i.e., the image that is joined to the lenticular lens to create the lenticular image). The process results in direct creation of lithographic separations either in the form of a film or, preferably, a plate. In the art, this is known as Computer to Plate (or “CTP”). In a CTP workflow, images that will be printed are plotted directly to the printing plate from digital data without any intermediary film. In CTP processing, every plate is considered to be a “master” that is made directly from the same digital data. CTP processing can produce sharper dots than conventionally imaged plates. The dots register more effectively, more faithfully reproduce more of the tonal range, generate less dot gain. Thus, using CTP, better image resolution and correspondence can be achieved, and better registration can be obtained from plate-to-plate and from color to color.

Exemplary digital plate types that are currently available include: a photopolymer such as the N90-A; a silver halide such as Lithostar and Silverlith; hybrids composed of both a photopolymer and a silver halide; and thermal plates. All of these technologies are capable of generating high quality printing, though it is noted that photopolymer plates offer the advantage of long run lengths (e.g., on the order of 500,000 runs or more) and silver halide plates support finer screen rulings (e.g., on the order of 175 lpi or more).

Referring to FIG. 8, a lenticular image 70 incorporating a lenticular lens 72 having a plurality of lenticules 73 and an interlaced image 74 created according to one aspect of the present invention is shown. More specifically, the interlaced image is created from an interlaced image file that has been normalized in a coextending lenticular direction to increase a surface area of an interlaced image dot size, thereby reducing dot gain and associated degradation in the interlaced image joined to the lenticular lens. The interlaced image can be fractionally scaled. The interlaced image file can be created from a plurality of frame files such that at least one of the frames files is fractionally scaled. The interlaced image can be output using at least one of: an offset, rotogravure, inkjet, flexographic, digital direct-to-plate and computer-to-plate output device.

By way of example, the lenticular image 70 can comprise a lenticular lens (a “100 line lens”) having a pitch of 101.5 lpi. The interlaced image can comprise 12 frames. An output resolution of 1218 dpi will result. Similarly, if the lens were a 205 lpi lens, with 6 frames, a resolution of 1230 dpi will result. Doubling the number of frames used in the lenticular image from 12 to 24, or from 6 to 12 in these examples, respectively, would result in an output resolution of 2436 and 2460 dpi, respectively. Accordingly, without fractionally scaling and normalizing, dot size will decrease about 50%. This in turn, can result in substantial dot gain.

Methods have been described and outlined in a sequential fashion. Still, rearrangement, combination, reordering, completing steps in substantially simultaneous fashion, or the like, of the methods is contemplated and considered within the scope of the appending claims. Moreover, the present invention has been described in terms of various embodiments (e.g., the amount or fraction associated with fractional scaling and normalizing, screening or compression techniques, specific file and image sizes, resolutions, lenticular lens counts or resolutions, etc.). Thus, it is recognized that equivalents, alternatives, and modifications, aside from those expressly stated, are possible and well within the scope of the appending claims.

1. An lenticular image file manipulation method for use with high resolution output devices the method comprising:
providing a plurality of frame files;
compressing the frame files in a translenticular direction to obtain a plurality of compressed frame files;
fractionally scaling the compressed frame files in the coextending lenticular direction to obtain a plurality of fractionally scaled, compressed frame files;
interlacing the fractionally scaled, compressed frame files to create an interlaced frame file;
screening the interlaced frame file to obtain a compressed, screened, interlaced image file; and
normalizing the compressed, screened, interlaced frame file in the coextending lenticular direction prior to output of the file.

2. The method of claim 1 wherein the translenticular direction corresponds to a direction that is transverse to a plurality of lenticules of a lenticular lens to which the interlaced image file, when output using the high resolution output device, will be joined.

3. The method of claim 1 wherein the coextending lenticular direction corresponds to a direction that is parallel to a plurality of lenticules of a lenticular lens to which the interlaced image file, when output using the high resolution output device, will be joined.

4. The method of claim 1 wherein the normalizing scales by a normalizing scaling factor and the fractionally scaling scales by a fractional scaling factor such that the normalizing scaling factor is inversely proportional to the fractional scaling factor.

5. The method of claim 1 wherein the manipulation is a screening process.

6. The method of claim 5 wherein the fractional scaling factor is less than 1 and the normalizing scaling factor is greater than 1.

7. The method of claim 1 wherein the normalizing increases a surface area of an high resolution output dot size.

8. The method of claim 1 wherein the fractional scaling decreases lenticular image frame memory usage.

9. The method of claim 1 wherein the fractional scaling and normalizing permit additional frame files to be interlaced for a given interlaced frame file size.

10. An lenticular image file manipulation method for use with output devices, the method comprising:
normalizing a fractionally scaled interlaced image file in a coextending lenticular direction to increase a surface area of an output dot size; wherein the increased surface area of the output dot size results in reduced dot gain in the output.

11. The method of claim 10 further comprising fractionally scaling the interlaced image file.

12. The method of claim 10 wherein the interlaced image file comprises a plurality of frame files and wherein the method further includes fractionally scaling each of the plurality of frame files.

13. A lenticular image comprising:
a lenticular lens; and
an interlaced image joined to the lenticular lens;
wherein the interlaced image is created from interlaced image file that has been normalized in a coextending lenticular direction to increase a surface area of an interlaced image dot, thereby reducing dot gain and associated print degradation in the interlaced image joined to the lenticular lens

14. The lenticular image of claim 13 wherein the interlaced image file is fractionally scaled.

15. The lenticular image of claim 13 wherein the interlaced image file is created from a plurality of frame files and at least one of the frames files are fractionally scaled.

16. The lenticular image of claim 13 wherein the interlaced image is output using at least one of: an offset, rotogravure, flexographic, inkjet, digital direct-to-plate and computer-to-plate output device.
